(19) United States
(12) Patent Application Publication
(10) Pub. No.: US 2006/0049021 A1
(43) Pub. Date: Mar. 9, 2006

(54) Limit control

(76) Inventors: Michael Kevin Scheib, Auckland (NZ); Andrew Jones, Hamilton (NZ)

Correspondence Address: JACOBSON HOLMAN PLLC, 400 SEVENTH STREET N.W., SUITE 600, WASHINGTON, DC, 20004, US

(21) Appl. No.: 10/534,503

(22) PCT Filed: Sep. 16, 2003
(86) PCT No.: PCT/NZ03/00212

§ 371 Date: Aug. 1, 2005

(30) Foreign Application Priority Data
Nov. 12, 2002 (NZ) 522578

(51) Int. Cl. E05F 15/10

(52) U.S. Cl. 192/139

(57) ABSTRACT

Apparatus adapted for use to reference a cam actuable switch or the like means to the disposition of a drive in a datum range (e.g.; the movement of a member between open and closed conditions under the action of the drive), said apparatus having, dependent on the drive, an eccentric member, a spur gear carried by yet free to rotate relative to the eccentric member, a ring gear with its inwardly directed teeth in an epicyclic meshing relationship with the spur gear, and a cam (or other datum providing interactive means component) [“cam”] rotatable with the spur gear adapted to interact, intended, capable of or suitable for being adapted to interact with a switch or the like means, wherein there is an adaption or a capability whereby both any such switch or the like means (save for its switch activation movement, if any) is or can be in a substantially fixed relationship with said ring gear when in use.

### TECHNICAL FIELD

The present invention relates to apparatus and related methods and procedures for referencing a rotary drive with the limits of movement required for that drive to take account of a particular application (e.g.; of the movement limits a door opening or closing, or the like).

### BACKGROUND ART

There are many instances where a drive system requires calibration so as to ensure that the electric motor (or other prime mover) does not continue to drive or drive effectively in its application beyond limits of that application. For example, in the situation with, for example, garage doors, whether of the curtain, tilt or sectional types it is usual (irrespective of whether or not AC or DC motors are being used as the motive force) to provide limits whereby there is a cut-off of the energising power to the motor when the door is either fully open or fully closed.

Frequently such cut-off systems are dependent upon manual inputs by way of screws or the like members that allow the limits to be customised for the particular application.

The present invention relates to apparatus and related procedures and the like that has application inter alia in such applications as the limit control of, for example, garage doors but has more widespread application.

In our New Zealand Patent Specification No. 522300 we disclosed a novel drive system whereby a motor driven worm engages a worm gear and that worm gear in turn has or drives a sprocket or pulley that acts upon an endless drive member (such as a chain or belt) which in turn moves a guided carriage which is directly or indirectly attached to the door, e.g.; a tilt type garage door.

In the aforementioned New Zealand Patent Specification we disclosed an assembly having significant advantages over prior art structures in that a simple moulded member of a suitable plastics material or other suitable material could be provided which could be mounted on a fixed or rotating shaft mounted from chassis components at each end, such moulded member at one end driving the sprocket, pulley or the like and at the other end, or towards the other end, having a worm gear integrally formed therewith adapted to be driven by the worm driveable by a power output shaft from, for example, an AC electric motor. The full disclosure of the aforementioned New Zealand Patent Specification is hereby here included.

It is an object of the present invention to provide apparatus, methods, procedures and the like which will at least meet one of the abovementioned capabilities, or can be used in conjunction with the aforementioned drive system assembly and/or which at least provides the public with a useful choice.

### DISCLOSURE OF INVENTION

In a first aspect the invention is apparatus adapted for use to reference a cam actuable switch or the like means to the disposition of a drive in a datum range (e.g.; the movement of a member between open and closed conditions under the action of the drive), said apparatus having,
dependent on the drive, an eccentric member,
a spur gear carried by yet free to rotate relative to the eccentric member,
a ring gear with its inwardly directed teeth in an epicyclic meshing relationship with the spur gear, and
a cam (or other datum providing interactive means component) [“cam”] rotatable with the spur gear adapted to interact, intended, capable of or suitable for being adapted to interact with a switch or the like means,
wherein there is an adaption or a capability whereby both any such switch or the like means (save for its switch activation movement, if any) is or can be in a substantially fixed relationship with said ring gear when in use.

Preferably the drive is rotatable on a rotation axis about which the eccentric member orbits.

Preferably said ring gear includes means to index into an appropriately provided mount which also serves at least in part as a mount for a switch or the like means to be actuated by the cam.

Preferably the cam is mounted from a member rotatable with a member slidingly encompassing the ring gear but which itself is indexable to rotate about the rotation axis under the action of the eccentrically carried spur gear.

Preferably there is a differential in teeth numbers between the spur gear and the ring gear.

Preferably the differential is a low integer and most preferably one or two.

Preferably the teeth number differential is such as to provide a reduction drive from the rotatable drive which carries the eccentric member through to the cam which rotates about the same said rotation axis.

Preferably the eccentric drive is eccentrically extending from a moulded member which includes a worm gear adapted to be driven by a worm.

Preferably said moulded member additionally includes spline or other means adapted to engage a drive, sprocket, pulley, gear or the like adapted to open and/or close a door or the like (such as a garage door).

Preferably the moulded member is a moulded member of the kind defined and preferably one mounted as described in New Zealand Patent Specification No. 522300.

In yet a further aspect the present invention consists in apparatus adapted to rotate a cam (or other datum providing interactive means component) [“cam”] about a rotation axis, said apparatus having,
dependent on a rotatable drive on said rotation axis, an eccentric member to orbit the rotation axis,
a spur gear carried by yet free to rotate relative to the eccentric member,
a ring gear with its inwardly directed teeth in an epicyclic meshing relationship with the spur gear yet fixed relative to and so as not to rotate about the rotation axis, and
a cam rotatable about the rotation axis under the action of the spur gear,
(and optionally and preferably) a mounting for or fixed in respect of
(i) the rotational axis of said drive on which the eccentric member is dependent and
(ii) the ring gear.

Preferably said ring gear includes means to index into an appropriately provided mount which also serves at least in part as a mount for a switch or the like means to be actuated by the cam.

Preferably the cam is mounted from a member rotatable with a member slidingly encompassing the ring gear but which itself is indexable to rotate about the rotation axis under the action of the eccentrically carried spur gear.

Preferably there is a differential in teeth numbers between the spur gear and the ring gear.

Preferably the differential is a low integer and most preferably one or two.

Preferably the teeth number differential is such as to provide a reduction drive from the rotatable drive which carries the eccentric member through to the cam which rotates about the same said rotation axis.

Preferably the eccentric drive is eccentrically extending from a moulded member which includes a worm gear adapted to be driven by a worm.

Preferably said moulded member additionally includes spline or other means adapted to engage a drive, sprocket, pulley, gear or the like adapted to open and/or close a door or the like (such as a garage door).

Preferably the moulded member is a moulded member of the kind defined and preferably one mounted as described in New Zealand Patent Specification No. 522300.

In yet a further aspect the present invention consists in apparatus adapted to rotate a cam (or other datum providing interactive means component) [“cam”], said apparatus having,
dependent on a rotatable drive, a rotatable drive axis orbiting eccentric member,
a spur gear carried by yet free to rotate relative to the eccentric member,
a ring gear with its inwardly directed teeth in an epicyclic meshing relationship with the spur gear,
a cam rotatable about the rotation axis under the action of the spur gear, and
a mounting for or fixed in respect of
(i) the rotational axis of said drive on which the eccentric member is dependent, and
(iii) the ring gear.

Preferably said ring gear includes means to index into an appropriately provided mount which also serves at least in part as a mount for a switch or the like means to be actuated by the cam.

Preferably the cam is mounted from a member rotatable with a member slidingly encompassing the ring gear but which itself is indexable to rotate about the rotation axis under the action of the eccentrically carried spur gear.

Preferably there is a differential in teeth numbers between the spur gear and the ring gear.

Preferably the differential is a low integer and most preferably one or two.

Preferably the teeth number differential is such as to provide a reduction drive from the rotatable drive which carries the eccentric member through to the cam which rotates about the same said rotation axis.

Preferably the eccentric drive is eccentrically extending from a moulded member which includes a worm gear adapted to be driven by a worm.

Preferably said moulded member additionally includes spline or other means adapted to engage a drive, sprocket, pulley, gear or the like adapted to open and/or close a door or the like (such as a garage door).

Preferably the moulded member is a moulded member of the kind defined and preferably one mounted as described in New Zealand Patent Specification No. 522300.

In still a further aspect the present invention consists in apparatus for providing a physical reference or datum between a rotatable drive to operate over a datum range of multiple rotation(s), said apparatus having said rotatable drive drivingly rotatable directly or indirectly under the action of an electric motor about a rotation axis, an eccentric member carried by the rotatable drive so as to orbit the rotational axis thereof as the rotatable drive rotates,
a spur gear carried by yet free to rotate relative to the eccentric member,
a ring gear with its inwardly directed teeth in an epicyclic meshing relationship with the spur gear,
a cam (or other datum providing interactive means component) [“cam”] rotatable about the rotation axis under the action of the spur gear,
a switch actuable by the cam in a condition that references the rotatable drive to the datum range of rotation(s), whereby in use the switch is in a fixed angular disposition about the rotational axis as is also the ring gear.

Preferably the apparatus is apparatus also as otherwise defined herein.

In still a further aspect the present invention consists in a method of limiting a rotatable drive which employs the operative use of apparatus of any of the forms herein before described.

In yet a further aspect the present invention consists in a limit system suitable for use inter alia with, for example, a garage door which limits the rotation of a rotational drive, the rotational drive being referenced by electronic means to a physical datum or reference between the rotational drive and a switch to which the electronic means references thereby, by reference to the actuation and/or non actuation, or both, of the switch of determining whether or not a or one of the limits has been reached.

For example, preferably the mode of operation is substantially as hereinafter described (irrespective of whether or not it uses apparatus hereinafter described) with reference to FIGS. 1 to 12 of the accompanying drawings.

In still a further aspect the present invention consists in related methods and/or apparatus.

In another aspect the present invention consists in a limit protocol for a door opening system where a physical switch or the like established datum ancillary to the drive system for door opening/closing is utilised to establish a drive operation range of the drive system extending to either side of the datum.

Preferably the datum is established reliant upon a physical interaction of a epicyclic including transmission ancillary to the drive but receiving input directly or indirectly of the drive (e.g.; through an eccentric input).

In still a further aspect the present invention consists in related methods and/or apparatus.

As used herein the term “cam” is to be provided with the broadest conceivable interpretation. Whilst preference is hereinafter described by reference to a peripherally outstanding ramp or ramped land other component forms with a physical interactive feature can be utilised. Indeed alternatives to a direct mechanical interaction can be within the scope of the present invention, i.e.; instead of a physical cam interacting with a follower of a switch instead some interactive means component intended to provide an optical, magnetic or electrical interactive relationship can be substituted in the stead of the physical cam/cam follower inter-reaction.

As used herein the term “datum range” contemplates, by way of example, by reference to a garage door, the rotations in whole and in part of a rotatable drive to the extent to which such rotations relate to the limits of movement of the door between any desired fully open or partly open condition and any desired fully closed or partly closed condition. Similar meanings extend to other applications of the limit system whether relating to a door or not.

As used herein the term “electronic means” can include any logic system, PLC dependent system, microprocessor dependent system or the like that in preferred forms of the present invention are capable of being utilised to control the limits from the datum preferably established by a physical interaction between the cam and the switch.

As used herein the term “physical datum or reference” can include within its scope interactions of the kind aforementioned which may not be dependent on a physical coming but may instead be of an optical, electrical, magnetic or the like interaction.

In still other aspects the present invention consists in a door or the like limit system controlled by apparatus and/or methods and/or systems in accordance with the present invention.

In still a further aspect the present invention consists in, in combination, any of the apparatus, systems or methods of the aforementioned New Zealand Patent Specification No. 522300 and any of the apparatus, methods and systems of the present invention.

By way of example, apparatus of the aforementioned New Zealand Patent Specification includes
(A) a drive assembly of or suitable for use in a door opener transmission from a
   motor, comprising or including
   a supported axle member,
   a sleeve carried by the axle member so as to rotate coaxially thereabout (irrespective of whether or not the axle itself is allowed to rotate), said sleeve defining or having a worm gear coaxial with the sleeve axis and having one end adapted to engage a complementary sprocket, pulley or the like drive for a flexible drive element such as a chain, belt or the like,
   a worm driveable directly or indirectly by the or a motor, said worm meshing with the worm gear of the sleeve, and
   a sprocket, pulley or the like member engaged with said end of the sleeve so as to rotate with the sleeve about the sleeve axis;
(B) a drive assembly of or suitable for use in a door opener transmission from a motor, comprising or including
   a first chassis component,
   a second chassis component supported (directly or indirectly) so as to hold a fixed position with respect to the first chassis component,
   an axle member supported at each end by said first and second chassis components,
   a sleeve carried by the axle member so as to rotate coaxially thereabout between the first and second chassis components (irrespective of whether or not the axle itself is allowed to rotate), said sleeve defining or having a worm gear coaxially with the sleeve axis and having one end adapted to engage a complementary sprocket, pulley or the like drive for a flexible drive element such as a chain, belt or the like (or optionally itself defining or having such a sprocket, pulley or the like [e.g.; integrally moulded]),
   a worm rotatably mounted relative to and/or by at least said first chassis component so as to be driveable by the motor, said worm meshing with the worm gear of the sleeve,
   (optionally) said motor, and
   a said sprocket, pulley or the like member between said first and second chassis components engaged with said end of the sleeve (or optionally of the sleeve) so as to rotate with the sleeve about the sleeve axis;
(C) a drive assembly of or suitable for use in a door opener transmission from a motor, comprising or including
   a first chassis component,
   a second chassis component supported (directly or indirectly) so as to hold a fixed position with respect to the first chassis component,
   an axle member supported at each end by said first and second chassis components,
   a sleeve carried by the axle member so as to rotate coaxially thereabout between the first and second chassis components (irrespective of whether or not the axle itself is allowed to rotate), said sleeve defining or having a worm gear coaxially with the sleeve axis and having one end adapted to engage a complementary sprocket, pulley or the like drive for a flexible drive element such as a chain, belt or the like (or optionally itself defining or having such a sprocket, pulley or the like [e.g.; integrally moulded]),
   a worm rotatably mounted relative to and/or by at least said first chassis component so as to be driveable by the motor, said worm meshing with the worm gear of the sleeve, and
   a said sprocket, pulley or the like member between said first and second chassis components engaged with said end of the sleeve (or optionally of the sleeve) so as to rotate with the sleeve about the sleeve axis, and
   (optionally) also said motor drivingly connected to said worm, and
   (optionally) a chain, belt or the like drivingly connected to said sprocket, pulley or the like, and
   (optionally) an idle sprocket, pulley or the like for the chain, belt or the like, and
   (optionally) a door connected or connectable carriage driveable by said chain, belt or the like; and
(D) a sprocket and worm gear assembly substantially as herein described with reference to any one or more of the accompanying drawings.

As used herein the term “and/or” means “and” or “or”, or both where the circumstances allow.

As used herein the term “(s)” following a noun means both or either the plural and singular forms of that noun.

As used herein the term “/” between nouns (e.g. as used hereinafter as “opening/closing” means both the opening and closing functions or either.

For the purpose of the use of systems of the present invention in garage door openings reference is drawn to the website of www.merlingo.com/ as demonstrating apparatus and forms appropriate for such control.

### BRIEF DESCRIPTION OF DRAWINGS

A preferred form of the present invention will now be described with reference to the accompanying drawings in which

FIG. 1 is an exploded diagram of apparatus in accordance with the present invention,

FIG. 2 is a plan view of an assembly of the components of FIG. 1,

FIG. 3 is a side elevational view of the apparatus of FIG. 2,

FIG. 4 is a section on “AA”,

FIG. 5 is a section on “BB”,

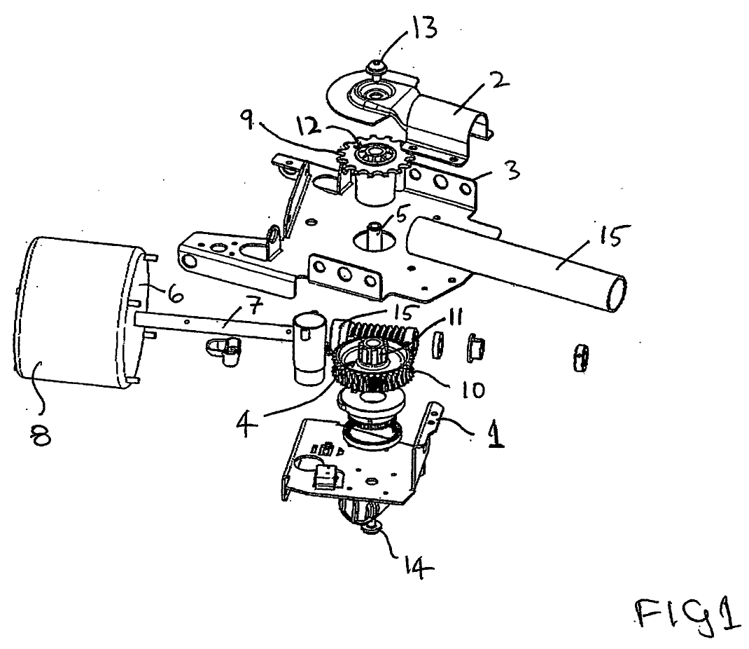

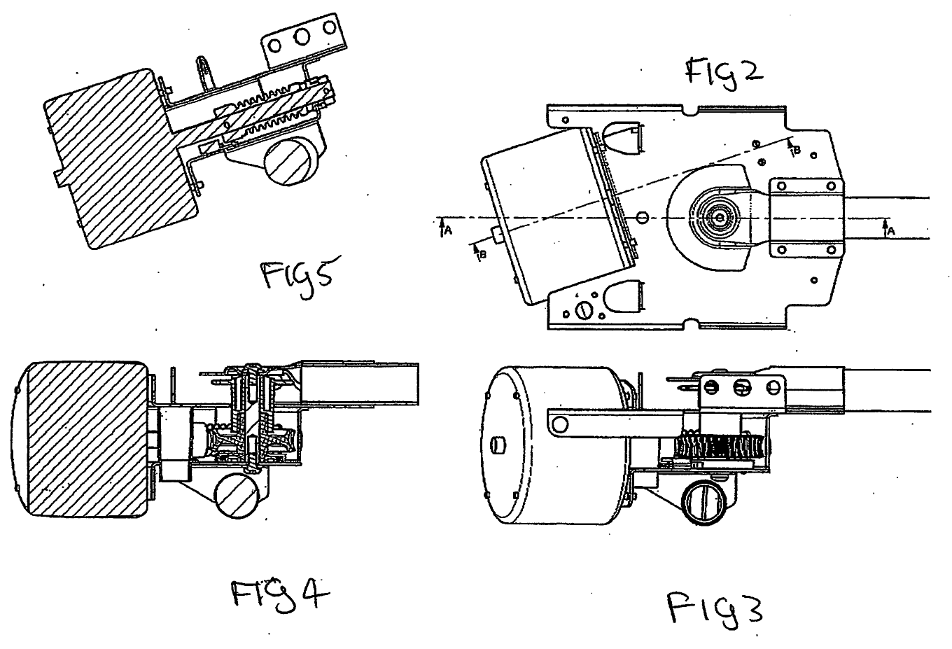

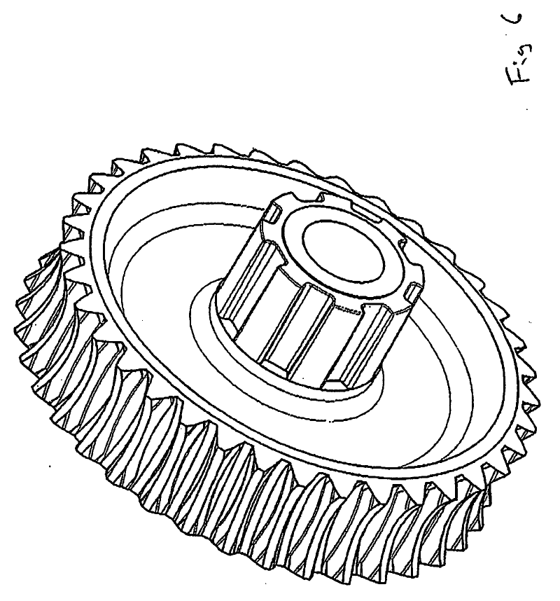

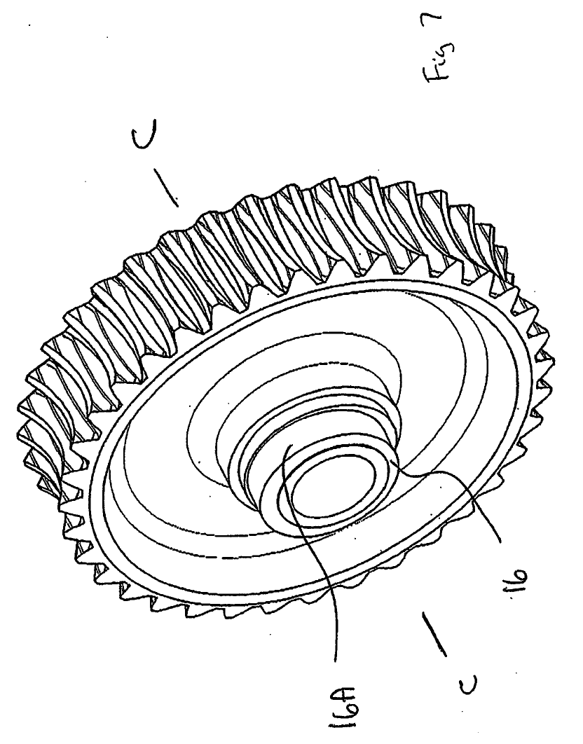

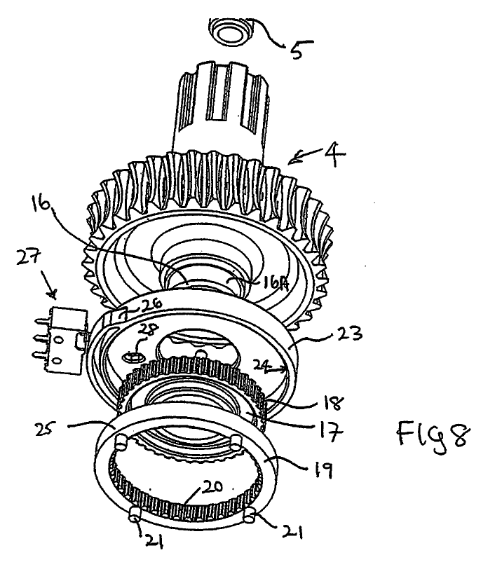

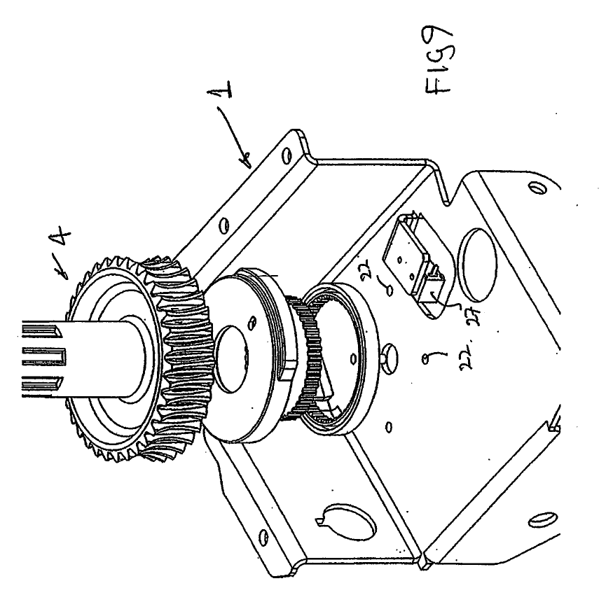

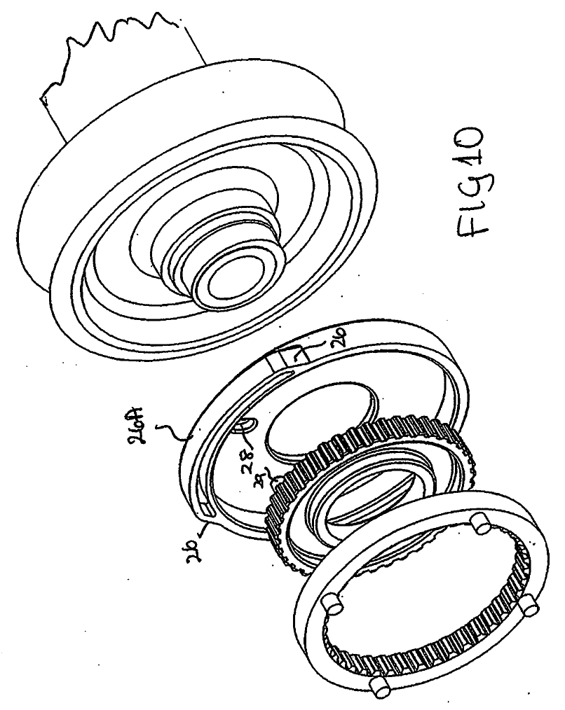

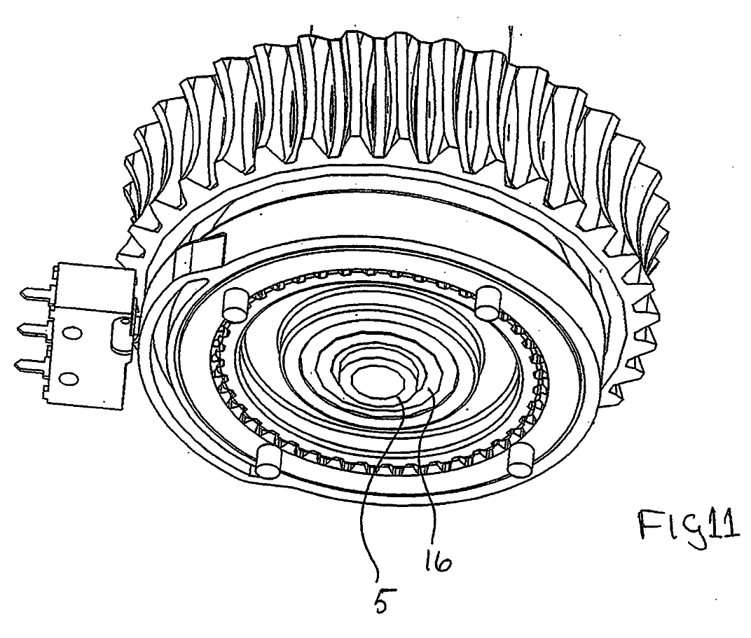

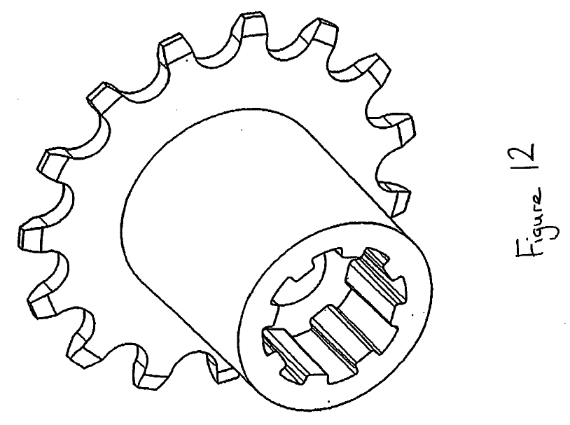

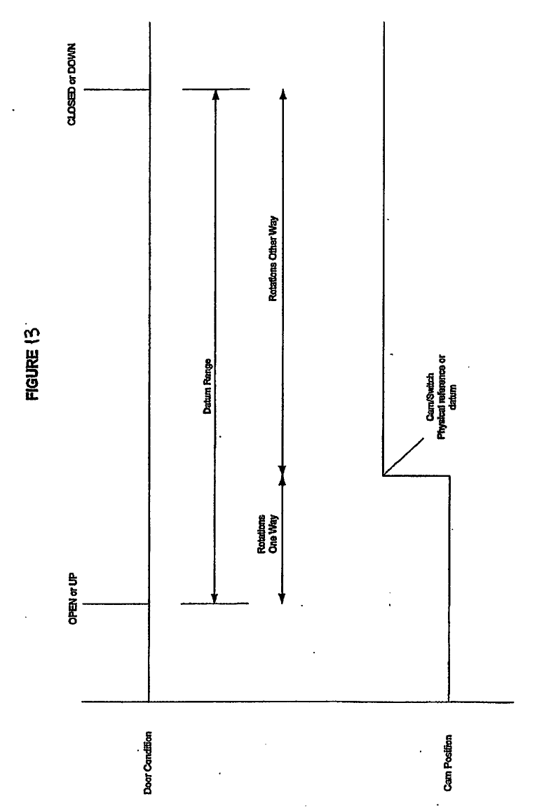

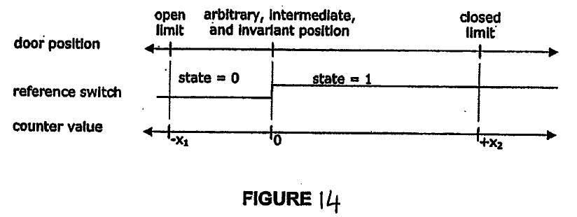

FIGS. 1 to 5 being as in New Zealand Patent Specification No. 522300,

FIG. 6 is one view of a preferred unitary moulded sleeve in accordance with the present invention defining a sleeve having a worm gear and a spline capable of engaging a complementary sprocket or the like,

FIG. 7 is a view of the moulded member of FIG. 6 from a different direction,

FIG. 8 is an exploded view from below of the main components of the limit system in accordance with the present invention,

FIG. 9 is a similar exploded view but from slightly above rather than below to that of FIG. 8 but showing the relationship of such components to a chassis component and the switch,

FIG. 10 is another exploded view of the components better showing the nature of the eccentric surface to journal the spur gear eccentrically of the rotational axis AA of the worm gear et al. shown in FIG. 7,

FIG. 11 shows the assembly of the components of FIGS. 8 and 10 as they are in operation,

FIG. 12 is a view of a sprocket of the assembly capable of being spline driven,

FIG. 13 is a diagram explaining the nature of one option for the datum range in conjunction with the physical datum or reference (preferably provided by the cam/switch actuation) and the allowed rotations to describe the datum range of rotations allowed to accord with a fully open and fully closed door, and

FIG. 14 is a diagram for use in our explanation of some functions and logic features of a preferred implementation of the present invention.

### BEST MODE FOR CARRYING OUT THE INVENTION

In a preferred form of the present invention some of the preferred components are as depicted in FIGS. 1 to 7 in which, formed in each instance from plate steel so as to perform their respective functions insofar as the present invention is concerned as well as ancillary functions in respect of control systems etc., are the first chassis component 1, the second chassis component 2 and the third chassis component 3.

The third chassis component 3 carries a pole 15 shown in part which has the function of spacing an idle sprocket from the drive sprocket 9 so that the endless chain can drive a carriage guided by the pole 15, that carriage in any suitable way (including those known) being linked to the door to be opened and/or closed by the apparatus.

As can be seen, the third chassis component 3 has an opening therethrough through which can pass the axle 5 as well as part of the sleeve 4 so that the splined or keyed end region 11 of the sleeve 4 can drivingly be received by the mating spline or key 12 of the sprocket 9. The sleeve also has integrally moulded therewith (e.g.; in nylon or acetyl plastic or phosphorus bronze) (see FIGS. 6 and 7) the worm gear 10 which meshes with the worm 15 (e.g.; of stainless steel or nylon or acetyl plastic) drivingly carried on the output shaft 7 from the motor (preferably AC but can be DC) 8 which is mounted to both the first and third chassis components by a motor support member 6 coupled to the electric motor.

As can be seen, provision is made in each of chassis components 1 and 2 for endwise location and fixing (by screws 14 and 13 respectively) of the axle 5, although in other forms of the present invention, any of the forms of end location of the axle member herein described can instead be utilised irrespective of whether or not they are the same at each end.

As shown in FIG. 1 are a variety of washers, thrust bearings and the like but overall it can be seen that little in the way of componentry is required with the system in accordance with the present invention when compared with those hitherto utilised.

It can also be seen that by having a significant span between the ends of the axle member 5 there is good resistance moment to any stresses placed through the sleeve 14 by the worm 15 against movement of the support for the worm gear. This provides significant advantages over previously constructions.

As will be appreciated any appropriate mount for the ends of the axle member can be provided. For example whilst a axially engaging screw at each end is shown in the drawings, persons skilled in the art will appreciate how, if desired, a frustoconical end region or some equivalent can be received by one or other of the first and second chassis components and some means be provided to locate the other end (whether the same or different). For example, frustoconical, domed or other profiled ends at each end could be appropriately received directly by plates profiled accordingly or thrust washers or the like associated therewith. There is no need for the mounting at each end to involve a screw engagement.

In the arrangement as shown in FIGS. 8 through 12 the moulded member 4 includes a cylindrical surface 16A of its eccentric drive 16 which is adapted to orbit the rotational axis CC yet in turn journal and thus orbit the spur gear 17 about the rotational axis CC whilst its teeth 18 mesh epicyclically with the inwardly directed teeth of the ring gear 19.

The ring gear 19 can be seen with the protuberances or projections 21 adapted to be received in openings of the chassis component 1 whereby the ring gear 19 is precluded from rotation whilst the spur gear 17 is allowed to rotate as it maintains at least some tooth to tooth engagement of an epicyclic nature with the ring gear teeth.

The cylindrical surface 25 of the ring gear 19 bears a location and sliding relationship with the inner cylindrical surface 24 of the cam 23 with its pair of opposed ramps (26) between which there is an outstanding land 26A. One or other of the ramps 26 is preferably the caming surface which bears against an appropriate follower of the switch 27 which, as shown, is preferably mounted in a fixed relationship with the ring gear 17 and chassis component 1 and preferably also the axle 5 into which preferably through the chassis component 1 an appropriate locating screw 14 is engaged.

Between the spur gear 17 and the cam member 23 is a rotational drive interaction reliant on a projection from one member being received by the other in such a way as there can be substantially radial relative movement. Preferably this can involve a projection 29 of the spur gear 17 (see FIG. 10) being received in the radial opening or slot 28 of the cam member.

In use therefore any appropriate electronic means can be utilised to provide the outcomes shown as being desirable by FIG. 13. Shown by the line “cam position” is a transition that indicates the cam/switch physical reference or datum that corresponds to one or other of the ramps 26 acting on the cam follower of the switch and the disparity between the lines on either side thereof reflects whether or not the switch is on the outer cylindrical surface of the cam component itself or up on the land 26A (it does not matter which is which).

With that datum, any suitable electronic means (whether a simple counter mechanism (PLC) or otherwise can be utilised to calibrate the number of full and/or part rotations allowed each way from that physical reference or datum thereby providing the datum range indicative of rotations on either side of the reference or datum and which accord with the door condition, i.e.; either open at one end or closed at the other.

Persons skilled in the art will appreciate how such a system with a minimum of moving parts reliant upon a small encompassed space reliant on low cost moulded components (e.g.; of any of the plastics previously referred to) can be utilised for limit control datum and/or datum range setting.

Persons skilled in the art also will appreciate how if a DC motor is utilised an override control can be incorporated somewhere in the system. If an AC motor is utilised persons skilled in the art will appreciate how an overload feature can be provided somewhere in the system such that should a door come down on a car or person the power is cut off to the motor in between the limits of the datum range.

Persons skilled in the art however will appreciate how the present invention provides for an effective way whereby a limit protocol of a door opening system (or any equivalent) can provide a physical, optical, magnetic or electrical switch interaction (switch established datum ancillary to the drive system for door opening/closing which can be utilised to establish a drive operation range of the drive system extending to either side of the datum. Less desirable is a circumstance but not outside the scope of the present invention, where the datum provided by the switching mechanism is outside of the datum range itself, i.e.; the rotations allowed are all to one side of the datum range. Nonetheless such possibilities exist and are within the scope of the present invention.

A description of the function and some underlying logic of the door controller limit system in one preferred or optional embodiment will now be described. It may use hardware as disclosed in our New Zealand Patent Specifications 522174 or 522300 filed 22 Oct. 2002 and 25 Oct. 2002 respectively, or indeed any mounting, assembly, subassembly and system we have disclosed by way of publication or use in respect of our MERLIN™ brand door systems.

Operation Before Setup

The manual control button ideally requires to be continuously depressed to move the door. Successive presses result in reversal of door travel direction. This ensures that the door can not accidentally be moved beyond the correct physical end-points of travel.

Set up

To define the limit positions the following process should be performed:
move the door to the desired open or closed limit position
store that position in memory
move the door to the other desired limit position
store that position in memory

Operation After Setup

A brief press of the manual control button will move the door from one limit to the other. Pressing the manual control button while the door is moving stops the door.

Controller Overview

The following controller inputs, outputs, and parameters are relevant:
the state of the reference switch: either 0 or 1
the state of the motor control relays: opening, closing, or stopped
the state changes of the position sensor: 0 or 1 for every k mm of door position (where k is a constant dependent on gearing, and type of sensor)
time
motor current

From these the controller can infer the position, speed and direction of the door's travel. With knowledge of the motor's torque-speed, and torque-current, characteristics the load placed on the motor can be inferred for any position of the door's travel.

If the controller has been reset, it can not determine whether its stored relative position is correct so it should recalibrate to the reference position. In order to decide which direction to travel first it checks the state of the reference switch and then moves towards the reference point. Once the reference switch has changed state, normal operation resumes. The user will be unaware of this unless they stop the door and try to move the door in the opposite direction before the reference switch changes state. In this circumstance the user will be required to continuously depress the manual control button.

On every uninterrupted operation from a limit position the counter will be set to zero at the reference switch. The counter values for the open and closed limits will be referenced to the newly calibrated reference position. See FIGS. 13 and 14.

Adaptive Travel Adjustment

The motor speed and/or current is stored with door position during setup. If during normal operation within a short distance of the bottom limit the speed and/or current does not match the stored values within some percentage then the physical limit position is judged to have been altered. The new limit position replaces the old limit position counter value.

1. Apparatus adapted for use to reference a cam actuable switch or the like means to the disposition of a drive in a datum range (e.g.; the movement of a member between open and closed conditions under the action of the drive), said apparatus having,
dependent on the drive, an eccentric member,
a spur gear carried by yet free to rotate relative to the eccentric member,
a ring gear with its inwardly directed teeth in an epicyclic meshing relationship with the spur gear, and
a cam (or other datum providing interactive means component) [“cam”] rotatable with the spur gear adapted to interact, intended, capable of or suitable for being adapted to interact with a switch or the like means,
wherein there is an adaption or a capability whereby both any such switch or the like means (save for its switch activation movement, if any) is or can be in a substantially fixed relationship with said ring gear when in use.

2. Apparatus of claim 1 wherein the drive is rotatable on a rotation axis about which the eccentric member orbits.

3. Apparatus of claim 1 wherein said ring gear includes means to index into an appropriately provided mount which also serves at least in part as a mount for a switch or the like means to be actuated by the cam.

4. Apparatus of claim 1 wherein the cam is mounted from a member rotatable with a member slidingly encompassing the ring gear but which itself is indexable to rotate about the rotation axis under the action of the eccentrically carried spur gear.

5. Apparatus of claim 1 wherein there is a differential in teeth numbers between the spur gear and the ring gear.

6. Apparatus of claim 5 wherein the differential is a low integer.

7. Apparatus of claim 6 wherein one or two.

8. Apparatus of claim 5 wherein the teeth number differential is such as to provide a reduction drive from the rotatable drive which carries the eccentric member through to the cam which rotates about the same said rotation axis.

9. Apparatus of claim 1 wherein the eccentric member dependent on the drive is eccentrically extending from a moulded member which includes a worm gear adapted to be driven by a worm.

10. Apparatus of claim 9 wherein said moulded member additionally includes spline or other means adapted to engage a drive, sprocket, pulley, gear or the like adapted to open and/or close a door or the like (such as a garage door).

11. Apparatus of claim 9 wherein the moulded member is a moulded member of the kind defined and preferably one mounted as described in New Zealand Patent Specification No. 522300.

12. Apparatus adapted to rotate a cam (or other datum providing interactive means component) [“cam”] about a rotation axis, said apparatus having,
dependent on a rotatable drive on said rotation axis, an eccentric member to orbit the rotation axis,
a spur gear carried by yet free to rotate relative to the eccentric member,
a ring gear with its inwardly directed teeth in an epicyclic meshing relationship with the spur gear yet fixed relative to and so as not to rotate about the rotation axis, and
a cam rotatable about the rotation axis under the action of the spur gear,
(and optionally and preferably) a mounting for or fixed in respect of
(i) the rotational axis of said drive on which the eccentric member is dependent and
(ii) the ring gear.

13. Apparatus of claim 12 wherein said ring gear includes means to index into an appropriately provided mount which also serves at least in part as a mount for a switch or the like means to be actuated by the cam.

14. Apparatus of claim 13 wherein the cam is mounted from a member rotatable with a member slidingly encompassing the ring gear but which itself is indexable to rotate about the rotation axis under the action of the eccentrically carried spur gear.

15. Apparatus of claim 12 wherein there is a differential in teeth numbers between the spur gear and the ring gear.

16. Apparatus of claim 15 wherein the differential is a low integer.

17. Apparatus of claim 16 wherein the differential is one or two.

18. Apparatus of claim 15 wherein the teeth number differential is such as to provide a reduction drive from the rotatable drive which carries the eccentric member through to the cam which rotates about the same said rotation axis.

19. Apparatus of claim 15 wherein the eccentric drive is eccentrically extending from a moulded member which includes a worm gear adapted to be driven by a worm.

20. Apparatus of claim 15 wherein said moulded member additionally includes spline or other means adapted to engage a drive, sprocket, pulley, gear or the like adapted to open and/or close a door or the like (such as a garage door).

21. Apparatus of claim 15 wherein the moulded member is a moulded member of the kind defined and preferably one mounted as described in New Zealand Patent Specification No. 522300.

22. Apparatus adapted to rotate a cam (or other datum providing interactive means component) [“cam”], said apparatus having,
dependent on a rotatable drive, a rotatable drive axis orbiting eccentric member,
a spur gear carried by yet free to rotate relative to the eccentric member,
a ring gear with its inwardly directed teeth in an epicyclic meshing relationship with the spur gear,
a cam rotatable about the rotation axis under the action of the spur gear, and
a mounting for or fixed in respect of
(i) the rotational axis of said drive on which the eccentric member is dependent, and
(ii) the ring gear.

23. Apparatus of claim 22 wherein said ring gear includes means to index into an appropriately provided mount which also serves at least in part as a mount for a switch or the like means to be actuated by the cam.

24. Apparatus of claim 22 wherein the cam is mounted from a member rotatable with a member slidingly encompassing the ring gear but which itself is indexable to rotate about the rotation axis under the action of the eccentrically carried spur gear.

25. Apparatus of claim 22 wherein there is a differential in teeth numbers between the spur gear and the ring gear.

26. Apparatus of claim 25 wherein the differential is a low integer.

27. Apparatus of claim 26 wherein the differential is one or two.

28. Apparatus of claim 25 wherein the teeth number differential is such as to provide a reduction drive from the rotatable drive which carries the eccentric member through to the cam which rotates about the same said rotation axis.

29. Apparatus of claim 22 wherein the eccentric drive is eccentrically extending from a moulded member which includes a worm gear adapted to be driven by a worm.

30. Apparatus of claim 29 wherein said moulded member additionally includes spline or other means adapted to engage a drive, sprocket, pulley, gear or the like adapted to open and/or close a door or the like (such as a garage door).

31. Apparatus of claim 22 wherein the moulded member is a moulded member of the kind defined and mounted substantially as described in New Zealand Patent Specification No. 522300.

32. Apparatus for providing a physical reference or datum between a rotatable drive to operate over a datum range of multiple rotation(s), said apparatus having said rotatable drive drivingly rotatable directly or indirectly under the action of an electric motor about a rotation axis, an eccentric member carried by the rotatable drive so as to orbit the rotational axis thereof as the rotatable drive rotates,
a spur gear carried by yet free to rotate relative to the eccentric member,
a ring gear with its inwardly directed teeth in an epicyclic meshing relationship with the spur gear,
a cam (or other datum providing interactive means component) [“cam”] rotatable about the rotation axis under the action of the spur gear,
a switch actuable by the cam in a condition that references the rotatable drive to the datum range of rotation(s), whereby in use the switch is in a fixed angular disposition about the rotational axis as is also the ring gear.

33. (canceled)

34. A method of limiting a rotatable drive which employs the operative use of the apparatus of claim 1.

35. The limit system which limits the rotation of a rotational drive, whereby the rotational drive is referenced by electronic means to a physical datum or reference between the rotational drive and a switch to which the electronic means references thereby, by reference to actuation and/or non actuation, or both, of the switch of determining whether or not a or one of the limits has been reached.

36. The limit system of claim 35 for a door, window or the like closing system.

37. The limit system of claim 35 wherein the mode of operation is substantially as herein described with reference to FIG. 12 of the accompanying drawings (irrespective of whether or not it uses apparatus herein described with reference to FIGS. 1 to 11 of the accompanying drawings).

38. (canceled)

39. The limit protocol for a door opening system where a physical switch or the like established datum ancillary to the drive system for door opening/closing is utilised to establish a drive operation range of the drive system extending to either side of the datum.

40. The protocol of claim 39 wherein

40. The protocol of claim 39 wherein the datum is established reliant upon a physical interaction of a epicyclic including transmission ancillary to the drive but receiving input directly or indirectly of the drive.

41. The protocol of claim 40 wherein the input is through an accentric input.
